(19) United States
(12) Patent Application Publication
(10) Pub. No.: US 2026/0006559 A1
(43) Pub. Date: Jan. 1, 2026

(54) METHOD FOR MANAGING THE PUTTING ON STANDBY OF A RADIO RESOURCE OF A WIRELESS ACCESS-POINT DEVICE, STANDBY-MANAGEMENT DEVICE, AND WIRELESS ACCESS-POINT DEVICE

(71) Applicant: SAGEMCOM BROADBAND SAS, Bois-Colombes (FR)

(72) Inventors: Mouna SOUILEM, Bois-Colombes (FR); Rami BELKAROUI, Bois-Colombes (FR); Sylvain LE ROUX, Bois-Colombes (FR)

(73) Assignee: SAGEMCOM BROADBAND SAS, Bois-Colombes (FR)

(21) Appl. No.: 19/231,170

(22) Filed: Jun. 6, 2025

(30) Foreign Application Priority Data
Jun. 26, 2024 (FR) 2406861

(51) Int. Cl. H04W 52/02; H04L 41/16

(52) U.S. Cl. CPC H04W 52/0274; H04L 41/16; H04W 52/0216

(57) ABSTRACT

A method for determining by prediction, using automated learning of the machine learning type, time ranges during which a radio interface of a wireless access point of a communication network can be switched off or put on standby, for energy-saving purposes.

### TECHNICAL FIELD

The present invention relates to the field of communication networks comprising one or more wireless access-point devices, in particular in domestic or business environments. The invention relates more precisely to an optimised method for switching off or putting on standby radio resources equipping one or more wireless access-point devices of a communication network.

### PRIOR ART

Wireless telecommunication networks use electromagnetic-wave communication interfaces, said interfaces conventionally being called radio interfaces, radios, or radio resources. For energy-saving purposes, the radio resources, distributed in devices or equipment of the wireless access point type, are not supplied constantly but can be switched off or put on standby. Various techniques for determining times of switching on or restarting radio resources exist, but have a high risk of seeing a radio interface switched off at a moment when a user is attempting to connect a station thereto to access the communication network. There is therefore a need to minimise this risk. The situation can be improved.

### DISCLOSURE OF THE INVENTION

One object of the present invention is to propose a method for switching off or putting on standby radio resources of wireless access-point devices of a communication network aimed at saving on electrical energy while reducing the risk of creating absences or interruptions of service at inopportune moments. Thus a method is proposed for determining, for each access point of a communication network, or more precisely for each radio resource of a communication network, a method for determining the most appropriate time ranges during which this radio resource can be put on standby.

For this purpose, a method is proposed for managing standby of a radio resource of a wireless access-point device of a communication network, the method comprising:
i) obtaining first information representing an absence of use by a station of said radio resource in relation to a first reference period referred to as learning period,
ii) determining one or more second periods, referred to as switching-off periods, from all or part of said first information and in relation to third periods, referred to as reference periods, each of the switching-off periods being of a duration less than or equal to said learning period, and each of the reference periods being shorter than said learning period and shorter than or equal to either one of the switching-off periods,
iii) putting said radio resource on standby during said switching-off period or periods,
the method being such that said determination of one or more switching-off periods comprises training an automatic (or automated) learning model implemented by a neural network.

According to one embodiment, said determination of one or more second periods is made from a first subset of said first information and a determination of a confidence index for an absence of connection, for each of said third periods, is made from a second subset of said first information, different from said first subset.

According to one embodiment, said automatic learning model is a two-class classification model according to which a first class is defined by an absence of connection of any station to said radio resource during a reference period in question and a second class is defined by a connection of at least one station connected to said radio resource during a reference period in question.

Another object of the invention is a device or circuit, referred to as “module for putting on standby” a radio resource of a wireless access-point device of a communication network, the module for putting on standby comprising electronic circuitry configured to implement:
i) obtaining first information representing an absence of use by a station of said radio resource in relation to a first reference period referred to as learning period,
ii) determining one or more second periods, referred to as switching-off periods, from all or part of said first information and in relation to third periods, referred to as reference periods, each of the switching-off periods being of a duration less than or equal to said learning period, and each of the reference periods being shorter than said learning period and shorter than or equal to either one of the switching-off periods,
iii) putting said radio resource on standby during said switched-off period or periods,
the module for putting on standby furthermore comprising electronic circuitry configured to make said determination of one or more switching-off periods from a training of an automatic learning model.

According to one embodiment, the module for putting a radio resource on standby furthermore comprises electronic circuitry configured to make said determination of one or more second periods from a first subset of said first information and a determination of a confidence index for an absence of connection, for each of said third periods, from a second subset of said first information, different from said first subset.

According to one embodiment, the module for putting a radio resource on standby furthermore comprises electronic circuitry configured to implement said automated learning by means of a two-class classification model according to which a first class is defined by an absence of connection of at least one station to said radio resource during a reference period in question and a second class is defined by a connection of at least one station connected to said radio resource during a reference period in question.

Another object of the invention is a wireless access-point device comprising at least one radio resource and a standby-management module as described above.

Another object of the invention is a communication network comprising at least one access-point device as aforementioned.

Another object of the invention is a computer program product comprising program code instructions for executing the steps of the method as previously described when this program is executed by a processor of a module for managing the putting on standby of a radio resource, as well as an information storage medium comprising such a computer program product.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates a communication network of the LAN type comprising wireless access-point devices, according to one embodiment;

FIG. 2 illustrates reference periods used for implementing automated learning of the use of a radio resource of a wireless access-point device and for implementing periods of putting this radio resource on standby, according to one embodiment;

FIG. 3 is a flow diagram illustrating steps of a method for putting a radio resource on standby, according to one embodiment; and

FIG. 4 is a diagram illustrating an example of internal architecture of a module for managing the putting of a radio resource on standby, according to one embodiment.

### DETAILED DISCLOSURE OF EMBODIMENTS

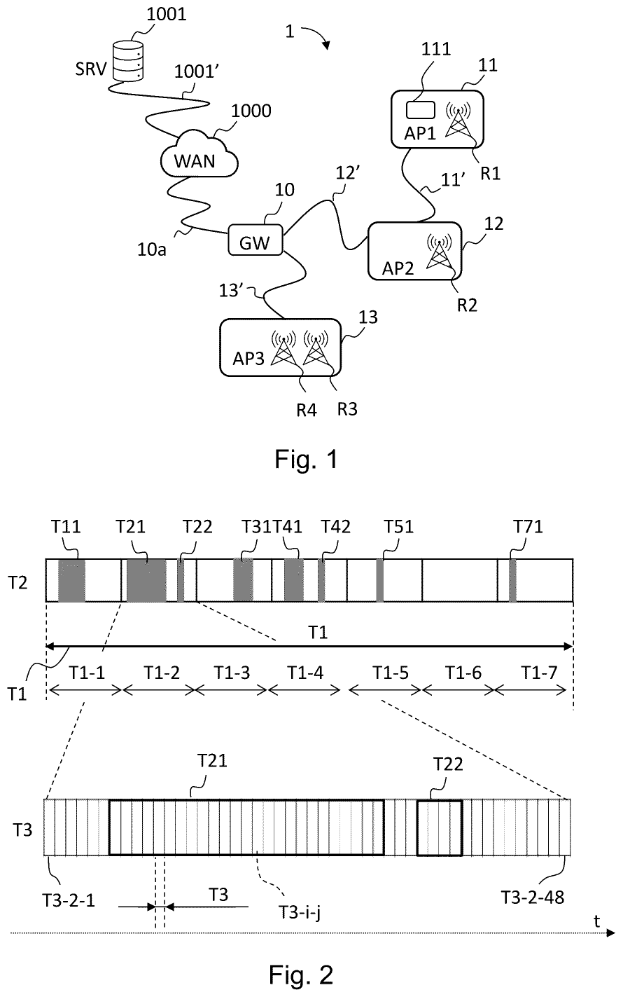

FIG. 1 illustrates a communication network 1 of the LAN type (from the English “Local Area Network”). The communication network 1 is connected to a wide area network 1000 of the WAN type (from the English “Wide Area Network”) by means of a home gateway GW 10 and a communication link 10a that connects the gateway GW 10 to the wide area network WAN 1000. According to the example embodiment described, the communication network 1 comprises three wireless access-point devices AP1 11, AP2 12 and AP3 13 each configured to make wireless connections between one or more stations (not shown in FIG. 1) and the communication network 1. According to the example embodiment described in FIG. 1, the wireless access-point device 11 is connected to the communication network 1 by means of the wireless access-point device 12, via a communication link 11′ established between the wireless access-point device 11 and the wireless access-point device 12. Still according to the example embodiment described, the wireless access-point device 12 is connected to the communication network 1 by means of the home gateway GW 10, via a communication link 12′. Finally, and still according to the example embodiment described, the wireless access-point device 13 is connected to the communication network 1 also by means of the home gateway GW 10, via a communication link 13′. The term “station” here designates any electronic and/or computer device configured to be connected to at least one LAN communication network, such as, for example, a fixed computer, a portable computer, a connected tablet, a connected smart television set, a smartphone, a connected watch, a connected domestic electrical appliance, an alarm or personal-assistance device, a radio programme receiver, a data storage device, etc, these examples obviously not being limitative. Naturally, other various electronic and/or computing devices can be connected to the communication network 1 but, for the purpose of simplification, these are not shown in FIG. 1. The wireless access-point device 11 comprises a radio resource R1; the wireless access-point device 12 comprises a radio resource R2; and the wireless access point device 13 comprises two radio resources R3 and R4. The terms “radio resource” or “radio” here designates an electronic interface configured to implement bidirectional wireless communications between a compatible remote device and the communication network 1, for example according to a protocol in the 802.11 family of standards of the Institute of Electrical and Electronics Engineers “IEEE”, or so-called Wi-Fi-type networks. Example embodiments can be placed for example in the context of IEEE 802.11-2020 or of amendment 802.11ax-2021 or of amendment IEEE 802.11be, in version D4.0 or version D5.0 thereof, or in subsequent versions thereof or the definitive version thereof. Other example embodiments can also be placed for example in the context of a version of IEEE 802.11 or of an amendment of this 802.11 standard incorporating amendment IEEE 802.11be, such as for example amendment IEEE 802.11bf D3.0 or amendment IEEE 802.11bn. They relate both to a domestic wireless network and to a business network.

The wireless access-point device 11 furthermore comprises a standby-management module 111. In a similar manner, the wireless access-point devices 12 and 13 comprise respectively a standby-management module 112 and a standby-management module 113. For simplification purposes, only the standby-management module 111 of the wireless access point 11 is shown in FIG. 1. The remainder of the description describes management of the putting on standby only of the radio resource R1 of the wireless access point 11, which applies in a similar manner to the standby-management modules of the wireless access-point devices 12 and 13. A remote server SRV 1001 is furthermore connected to the wide area network WLAN 1000 via a communication link 1001′. The remote server is configured to perform operations remotely, in particular data processing, and to communicate with equipment or devices of the communication network 1 in accordance with predefined communication protocols, in particular a communication protocol of the IP type. 25

Cleverly and according to at least one embodiment, the standby-management module 111 of the radio resource R1 of the wireless access-point device 11 is configured to implement, and implements, automated learning of the use made of the radio resource R1 over time. The terms “use of the radio resource R1” here designates, in relation to the radio resource R1, the fact of using or not the radio resource R1 at a given instant to establish a connection between the wireless access-point device 11 and one or more stations (i.e. one or more other devices that are connected to the communication network 1 via the radio resource R1). This notion of use furthermore, and more broadly, comprises the regularity or not of a connection, the frequency of the connection (for example a number of connections per hour, per day, per week, per month, etc) as well as the number of stations connected over the course of time (no station, a single station, two stations, three and more, etc).

The automated learning performed by the standby-management module 111 of the wireless access-point device 11 is implemented using recorded (stored) and timestamped connection information. According to one embodiment, all the information relating to the connections and disconnections of one or more stations that have occurred recently, i.e. for example in the course of the past weeks or months, are stored in a nonvolatile memory of the wireless access-point device, with a reference to each of the stations (for example a MAC address valid as a unique identifier) and timestamping references. According to a variant, this information, which constitutes a form of journal of the connections and disconnections for the radio resource R1 and more broadly the wireless access-point device 11, are recorded in a memory of the remote server SRV 1001, for the purpose of allowing the accumulation of a large number of data, but also a mutualised centralisation for all the wireless access-point devices of the communication network 1. Advantageously, this information, here called “first information”, represents a use or an absence of use by any station of the radio resource R1 in relation to a first reference period referred to as learning period. The standby-management module 111 is configured to proceed with an analysis of this first information for a reference learning period T1 that has particular interest in the sense of usage, for example a period of one week, a reiterated use of which is made, cyclically. This is because it very often happens that the users (human) of a communication network show recurrent behaviours on a weekly scale since everyday life is often organised according to a weekly timescale. For example, in the domestic context of a home, or even in a professional business context, habits in utilisation may be such that it is possible to identify, for one or more of the wireless access-point devices of a communication network, periods during which no station is generally connected. By way of example, it is possible to imagine a dwelling where nobody is present on Tuesday afternoon, subject to exception. According to another example, it is possible to imagine a business the offices of which are closed on Friday afternoon. According to yet another example, it is possible to imagine a business the shop of which is closed on Monday, but the office of which is occupied and used for performing management work. Thus it is possible to determine, by automated learning, periods during which the radio resource R1 of the wireless access-point device 11 is never acted on, in relation to a reference period such as the week running from Monday at 00:00 hours until the following Sunday at 23:59 hours. Like any time analysis, an analysis thus made requires to be implemented with a certain level of precision, also commonly referred to as “granularity”, and which needs other reference periods to be predefined in order not to have to process an excessively large amount of information while guaranteeing that the data stored for the analysis have a sure meaning. Thus, with regard to the analysis of the times and instants of connection and disconnection of stations to and from a communication network, it is possible to consider that a level of precision (and therefore a unit of time) of the order of one minute is too high, and that a level of precision of the order of half a day is much to low, it being a question, ultimately, of making electrical-energy savings. This is why the method for putting a radio resource on standby that is the object of one or more embodiments is designed with a temporality referring to several reference periods:
a first reference period that is a “learning period” T1, used reiteratively so as to detect regularities in terms of use of a radio resource, translatable in the form of second periods T2 during which one or more radio resources of a communication network 1 can be put on standby or switched off; the reference learning period T1 is preferentially one week, for the reasons mentioned previously, and
third reference periods T3 that define the precision or granularity of the analysis, for example periods with a duration of a quarter of an hour, half an hour or one hour.

FIG. 2 illustrates the time references T1, T2 and T3 that are the first periods T1, second periods T2 and third periods T3 described above in accordance with a graphical representation presenting the passage of time t on the X axis. The illustration shows, in the upper part of FIG. 2, a period T1 of one week, determined in relation to the radio resource R1, divided into seven days T1-1, T1-2, T1-3, T1-4, T1-5, T1-6 and T1-7. The bottom part of FIG. 2 presents by way of example details of the day T1-2 (and therefore a Tuesday), namely reference periods T3 that are 48 in number, here referenced T3-2-1 to T3-2-48, in accordance with a format T3-i-j where i is the number of the day in the first reference period T1 and j is the number of the third reference period T3 in the relevant day in the first reference period T1 (with a duration of one week). The periods T3 being 48 in number according to the example embodiment illustrated, each of the third reference periods T3 lasts for 30 minutes. These third time reference periods are called T3-2-1, T3-2-2, T3-2-3, etc. The result is that a detailed analysis by the standby-management module 111 of the wireless access-point device 11, operating cyclically over several reference periods T1, i.e. using collected data representing the use and therefore the absence of use of the radio resource R1 during several successive weeks, makes it possible to determine periods T2 of the week during which it is probable that no station is connected to the radio resource R1. The periods T3 are therefore 336 in number (48 half hours×7 days) for a reference period T1 equal to one week. According to the example described, these periods are the periods T11 on Monday (i.e. during T1-1); T21 and T22 on Tuesday (i.e. during T1-2); T31 on Wednesday (i.e. during T1-3); T41 and T42 on Thursday (i.e. during T1-4); T51 on Friday (i.e. during T1-5) and T71 on Sunday (i.e. during T1-7). According to the example shown, it may be seen that no period of putting the radio resource R1 on standby (or switching it off) is foreseeable on Saturday (i.e. during T1-6). For example, this may be the case if at least one station is routinely operational and connected to the communication network 1, via the radio resource R1, all Saturday, example if one or more smartphones are connected continuously to the communication network 1 via the radio resource R1.

Advantageously and according to one embodiment, the standby-management module 111 of the wireless access-point device 11 comprises a neural network having, in one example, an input layer that processes the first information including at least the day the week T1-i and the timeslot T3-i-j; a hidden layer composed of 64 neurons and configured to implement automated learning; an output layer having a sigmoid activation function, an Adam optimiser and a binary cross-entropy loss function. Obviously this example is not limitative and the standby-management module can be implemented in another form, such as for example a decision tree modelling possible results of a series of interconnected choices. This structure enables the standby-management module 111 to implement a classification model with two classes, namely a class 0 if no station is connected to the radio resource during the reference period T3 in question and a class 1 if at least one station is connected to the radio resource R1 during this reference period T3. The neural network of the standby-management module 111 therefore processes information coming from the first collected timestamped information (the information on connection and disconnection of the stations to and from the radio resource R1), said information indicating, for each reference period T3 of half an hour, whether or not at least one station is connected to the radio resource R1. Ideally, the learning phase is implemented over a total learning period of several weeks (and therefore several periods T1, successively), i.e. the learning phase is implemented iteratively for several reference periods T1. As a result it is possible to predict, for each reference period T3 of half an hour during a future or current week, what the probability is of a station being connected or not to the radio resource R1.

The same principle is applied to all the wireless access-point devices of the communication network 1. Automated learning is implemented for each of the wireless access-point devices 11, 12 and 13, through its internal standby-management module, said module comprising a neural network configured to do this.

According to a variant embodiment, the first information representing the use of each of the radio resources of the communication network 1 is collected by the remote server SRV 1001, which implements automated learning for each of the modules and next sends to it the determined periods T2 during which radio resources can be put on standby or switched off. The words “put on standby” here designate any method for reducing electrical energy making it possible to substantially limit the electrical consumption of a radio resource. This may be a simple standby, a deep standby or a complete switching off of the radio resource in question. For example, the radio resources can be electrically supplied by supply lines respectively controlled by electronic switches controlled from various standby-management modules such as the standby-management module 111.

According to a variant embodiment, the standby-management module is configured to operate using data relating to all the major resources applied to its inputs and presenting as an output data indicating standby prospects for each of the radio resources in the communication network 1.

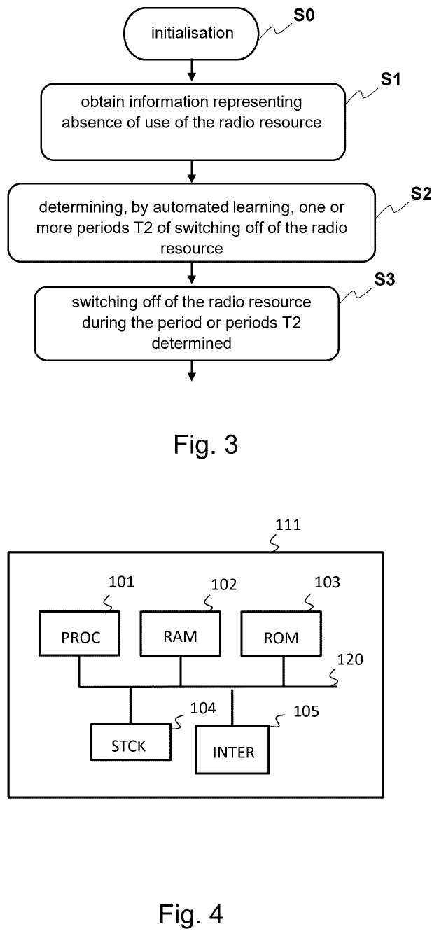

FIG. 3 is a flow diagram illustrating steps of a method implemented by the standby-management module 111 of the wireless access-point device 11 configured to determine periods T2 of putting the radio resource R1 on standby from predictions P on the use of the radio resource R1 by one or more stations at a given instant in the current week or a future week. A first step S0 is an initialisation step at the end of which all the devices in the communication network 1 are powered up and initialised to operate nominally. A step S1 is a step of collecting first information comprising in particular the information observed on connection and disconnection of one or more stations at the communication network 1 during one or more (but at least one) learning periods T1, including timestamping information. This information is stored, for example in the wireless access-point device 1 or in the remote server SRV 1001. A step S2 conditionally comprises an automated learning (or training or “machine learning”) phase during which the internal neural network of the standby-management module 111 is trained for determining periods T2 for which a certain level of probability P of absence of use of the radio resource R1 is determined, from first information collected and then formatted. If no machine learning phase has yet been implemented, then a machine learning phase is necessary and is implemented. If on the other hand a machine learning phase has already been implemented, then a new machine learning phase is optional. It should be noted however that, the more numerous the machine learning phases, the more precise and reliable will be the predictions delivered by the trained model. The neural network is trained by applying at its inputs and outputs first information collected and formatted, namely instants in the learning period T1 with reference to successive reference periods T3 as an input and information as to the connection of at least one station to the radio resource R1 or as to an absence of connection of any station to the radio resource R1 as an output. At the end of this learning, the neural network is therefore configured to provide a prediction P as to absence of connection of any station to the radio resource R1, for one or more successive reference periods T3 (K periods), said prediction P having, for each reference period T3, a confidence index C(P) representing a confidence level attributed to the prediction. Thus a probability level is next determined during a phase of using the trained model, there also using first information obtained, for each of the reference periods T3, resulting in the determination of standby periods T2. According to one embodiment, to do this it is analysed, during a series of K reference periods T3, whether at least N successive reference periods T3 have a prediction P according to which no station will be connected to the radio resource R1. This information is stored so as to be accessible subsequently. Once these possible standby periods T2 have been determined, a step S3 consists of a step of using these periods determined, during which the standby-management module 111 controls the radio resource R1 for going on standby and emerging from standby as applicable, and in accordance with the periods T2 determined.

According to one embodiment, the step S3 of controlling the putting of the radio resource R1 on standby is performed by sending of a switching-off command to the radio resource R1 in accordance with a predefined protocol, generic or proprietary, under the control of a dedicated controller (a module comprising electronic circuitry or a microprocessor, for example). According to an example embodiment, the commands are sent in accordance with a protocol conforming to a so-called “EasyMesh” standard, according to which a controller of the communication network concerned sends an Easy Mesh AP AutoConfiguration Renew message to an EasyMesh Agent in charge of the radio resource to be switched off of an access point of the communication network. The EasyMesh Agent next responds to this message by an EasyMesh AP Autoconfiguration WSC M1 message for the radio concerned, and more generally for all the radio resources for which it provides management. For each EasyMesh AP Autoconfiguration WSC M1 message, the controller next responds by an EasyMesh AP Autoconfiguration WSC M2 message containing the list of BSSs (Basic Service Sets) to be configured for the radio resource concerned. According to the example described here, advantageously and cleverly, and to proceed with the switching off of a given radio resource, the controller does not include any configuration concerning this radio resource in the EasyMesh AP Autoconfiguration WSC M2 message that is dedicated to this radio resource. On the other hand, for a command to switch on a radio resource following a switched-off period, the controller includes a configuration for the radio resource concerned in the EasyMesh AP Autoconfiguration WSC M2 message that is dedicated to it.

According to one embodiment, the set of training data (the first information) is divided into two information subsets (here the first information) one of which, the first, is used to make said predictions by means of the neural network, and the other, the second, is used to determine a confidence threshold Cs associated with each of the items of prediction information determined. Thus the predicted data are compared with real data, for predefined reference periods T3, and the value of the confidence threshold Cs is calculated so that X % of predictions P the associated confidence index C(P) of which is higher than or equal to Cs is true (in other words, the predicted value is equal to the real value). According to an example embodiment, X is equal to 100%.

According to one embodiment, the predictions on the presence or absence of at least one station connected to the radio resource R1 is determined for K future reference periods T3. The number K of successive reference periods for which a prediction P is determined is predefined. This is an input data of the algorithm implemented that can be adjusted in accordance with a compromise between the performance level and an amount of resources necessary for implementing the method and used by the algorithm. This number K is necessarily higher than an integer N that designates a block of N consecutive reference periods T3 during which it is predicted that the radio resource R1 will be inactive. The integer N here fulfils a “low-pass” filter function guaranteeing a certain level of continuity or of stability of the switching off or on of a radio resource to avoid excessively close-together variations. N is also an adjustable parameter of the algorithm, which can be modified remotely or by reconfiguration of low-level software (or “firmware”).

Thus, and according to one embodiment, each prediction P on the presence or absence of a station connected to the radio resource R1 is accompanied by a confidence index C(P), for example in the form of a decimal value lying in the interval [0,1]. For example, a prediction P determined for a period T3 equal to 1 (there will probably be a station connected) and with a confidence index C(P)=0.97 means that this probability P is estimated reliable at 97%. Associating a confidence index C(P) with a prediction P makes it possible to determine, for the radio resource R1, whether it is possible to put it on standby during one or more reference periods T3, then thus determining a standby or switching-off period T2 to be used in operating phase.

According to one embodiment, a radio resource Rn is to be switched off if, for N consecutive reference periods T3 (N<=K), the prediction P indicates that no station will be connected to this radio resource Rn, and if the confidence index C(P) attributed to this prediction P is higher than a threshold confidence index value Cs.

Thus, for each reference period T3, if the confidence index C(P) determined is higher than a predefined threshold value Cs and the prediction P is equal to 0, it is considered that the radio resource R1 will be inactive during this reference period T3. The predefined threshold value is configurable and depends on a required efficacy coefficient (also here referred to as the agressivity coefficient). The lower the threshold value, the more often will the radio resource R1 be switched off, which affords a significant saving in electrical energy but substantially increases the risk of causing a negative impact on user experience (by putting a radio resource on standby during a given period whereas a user ultimately wishes to connected thereto during the same period). On the other hand, a higher threshold value will result in greater availability of the radio resource R1, which will have a positive impact on user experience, but will lessen the electrical energy savings sought. Consecutive reference periods T3 for which the radio resource is predicted as being inactive then constitute the determined standby periods T2.

According to one embodiment, the steps S1, S2 and S3 are performed iteratively.

FIG. 4 illustrates schematically an example of internal architecture of a standby-management module 111 of the wireless access point 11. It should be noted that FIG. 4 could also represent an internal architecture of a wireless access point such as the wireless access-point device 12 or the wireless access-point device 13 or an internal architecture of a connection gateway device such as the home gateway GW 10. According to the example of hardware architecture shown in FIG. 4, the standby-management module 111 of the wireless access-point device 11 then comprises, connected by a communication bus 120: a processor or CPU (“central processing unit”) 101; a random access memory (RAM) 102; a read only memory (ROM) 103; a storage unit such as a hard disk (or a storage medium reader, such as an SD (Secure Digital) card reader 104; at least one communication interface 105 enabling the standby-management module 111 of the wireless access point 111 to communicate with other devices to which it is connected, such as the radio resources the switching off and restarting of which it controls, or external devices such as the home gateway GW10 or the remote server SRV 1001.

The processor 101 is capable of executing instructions loaded in the RAM 102 from the ROM 103, from an external memory (not shown), from a storage medium (such as an SD card), or from a communication network. When the standby-management module 111 of the wireless access-point device 11 is powered up, the processor 101 is capable of reading instructions from the RAM 102 and executing them. These instructions form a computer program causing the implementation, by the processor 101, of all or part of the method described in relation to FIG. 3 or described variants of this method.

All or part of the method described in relation to FIG. 3 or the described variants thereof can be implemented in software form by executing a set of instructions by a programmable machine, such as a DSP (“digital signal processor”) or a microcontroller, or be implemented in hardware form by a machine or a dedicated component, for example an FPGA (field-programmable gate array) or an ASIC (application-specific integrated circuit). In general, the standby-management module 111 of the wireless access point 11 comprises electronic circuitry configured to implement the methods described in relation to it. Obviously, the standby-management module 111 of the wireless access point 11 furthermore comprises all the elements usually present in a system comprising a control unit and the peripherals thereof, such as a power supply circuit, a power-supply monitoring circuit, one or more clock circuits, a reset circuit, input/output ports, interrupt inputs and bus drivers, this list being non-exhaustive.

1. A method for managing standby of a radio resource of a wireless access-point device of a communication network, the method comprising:
i) obtaining first information representing an absence of use by a station of said radio resource in relation to a first reference period referred to as learning period,
ii) determining one or more second periods, referred to as switching-off periods, from all or part of said first information and in relation to third periods, referred to as reference periods, each of the switching-off periods being of a duration less than or equal to said learning period, and each of the reference periods being shorter than said learning period and shorter than or equal to either one of the switching-off periods,
iii) putting said radio resource on standby during said switching-off period or periods,
the method for determining one or more switching-off periods comprising a phase of training an automated learning model, and the method being characterised in that:
said determination of one or more second periods is made from a first subset of said first information, and
a determination of a confidence index for each of said third periods is made from a second subset of said first information, different from said first subset.

2. The method for putting on standby according to claim 1, wherein said automatic learning model is a two-class classification model according to which a first class is defined by an absence of connection of any station to said radio resource during a reference period in question and a second class is defined by a connection of at least one station connected to said radio resource during a reference period in question.

3. A module for managing standby of a radio resource of a wireless access-point device of a communication network, the module for putting on standby comprising electronic circuitry configured to implement:
i) obtaining first information representing an absence of use by a station of said radio resource in relation to a first reference period referred to as learning period,
ii) determining one or more second periods, referred to as switching-off periods, from all or part of said first information and in relation to third periods, referred to as reference periods, each of the switching-off periods being of a duration less than or equal to said learning period, and each of the reference periods being shorter than said learning period and shorter than or equal to a switched-off period,
iii) putting said radio resource on standby during said switching-off period or periods,
the standby-management module furthermore comprising electronic circuitry configured to make said determination of one or more switching-off periods from a training of an automated learning model and being characterised in that it furthermore comprises electronic circuitry for implementing:
said determination of one or more second periods from a first subset of said first information, and
a determination of a confidence index for said third periods, from a second subset of said first information, different from said first subset.

4. The standby-management module of a radio resource according to claim 1, furthermore comprising electronic circuitry configured to implement said automated learning by means of a two-class classification model according to which a first class is defined by an absence of connection of at least one station to said radio resource during a reference period in question and a second class is defined by a connection of at least one station to said radio resource during a reference period in question.

5. The access-point device comprising at least one radio resource and a standby-management module of said radio resource, according to claim 4.

6. The communication network comprising at least one access-point device according to claim 5.

7. (canceled)

8. A non-transitory information storage medium comprising a computer program product program code instructions for executing the steps of the method according to claim 1, when said program is executed by a processor of a standby-management module of a radio resource.
